(19) United States
(12) Patent Application Publication
(10) Pub. No.: US 2014/0330826 A1
(43) Pub. Date: Nov. 6, 2014

(54) METHODS AND SYSTEMS FOR DATA REDUCTION IN CLUSTER ANALYSIS IN DISTRIBUTED DATA ENVIRONMENTS

(71) Applicant: SAS Institute Inc., Cary, NC (US)

(72) Inventors: Xiangqian Hu, Cary, NC (US); Xunlei Wu, Cary, NC (US); Xiangxiang Meng, Cary, NC (US); Oliver Schabenberger, Cary, NC (US)

(73) Assignee: SAS Institute Inc., Cary, NC (US)

(21) Appl. No.: 14/270,142

(22) Filed: May 5, 2014

Related U.S. Application Data
(60) Provisional application No. 61/819,532, filed on May 4, 2013.

(51) Int. Cl. G06F 17/30

(52) U.S. Cl. CPC G06F 17/30598
USPC 707/737

(57) ABSTRACT

Systems and methods for data reduction of a data set are included. A computing system may group data points in a data set into a number of data point bubbles represented by a number of representative points. A data point bubble may include a one or more data points from the data set and a representative point from the data set. The computing system may calculate a cluster assignment for the representative point by executing a clustering algorithm using the number of representative points.

### CROSS-REFERENCE TO RELATED APPLICATIONS

The present disclosure claims priority to U.S. Provisional Application No. 61/819,532, filed May 4, 2013 and titled “Methods and Systems for Data Reduction in Cluster Analysis in Distributed Data Environments,” the entirety of which is incorporated herein by reference.

### TECHNICAL FIELD

The present disclosure generally relates to computer-implemented systems and methods for data reduction in distributed data environments.

### BACKGROUND

Distance-based data mining analyses are attractive for addressing many problems in class identification and data segmentation. However, when handling large data sets, the computational cost of some clustering algorithms may become impractical or prohibitively expensive.

### SUMMARY

In accordance with the teachings provided herein, systems and methods for data reduction in distributed data environments are provided.

For example, a computer-program product tangibly embodied in a non-transitory machine-readable storage medium is provided that includes instructions that can cause a data processing apparatus to group data points in a data set into a plurality of data point bubbles. These data point bubbles are represented by a plurality of representative points where an individual point bubble of the plurality of data point bubbles includes one or more data points from the data set and a representative point of the plurality of representative points. The computer-program product further includes instructions that can cause the data processing apparatus to calculate a cluster assignment for the representative point by executing a clustering algorithm using the plurality of representative points.

In another example, a computer-implemented method is provided that includes grouping data points in a data set into a plurality of data point bubbles. These data point bubbles are represented by a plurality of representative points where an individual point bubble of the plurality of data point bubbles includes one or more data points from the data set and a representative point of the plurality of representative points. The method further includes calculating a cluster assignment for the representative point by executing a clustering algorithm using the plurality of representative points.

In another example, a system is provided that includes a processor and a non-transitory computer readable storage medium containing instructions that, when executed on the processor, cause the processor to perform operations. The operations include grouping data points in a data set into a plurality of data point bubbles. These data point bubbles are represented by a plurality of representative points where an individual point bubble of the plurality of data point bubbles includes one or more data points from the data set and a representative point of the plurality of representative points. The operations further include calculating a cluster assignment for the representative point by executing a clustering algorithm using the plurality of representative points.

### BRIEF DESCRIPTION OF THE DRAWINGS

The patent or application file contains at least one drawing executed in color. Copies of this patent or patent application publication with color drawings will be provided by the office upon request and payment of any necessary fee.

FIG. 1 illustrates an example block diagram of a computer-implemented environment for reducing a number of computations executed for a clustering algorithm that analyzes data sets in a distributed data environment.

FIG. 2 illustrates a block diagram of an example processing system of FIG. 1 for reducing a number of computations executed for a clustering algorithm that analyzes data sets in a distributed data environment.

FIG. 3 illustrates an example flow diagram for performing a distance based data mining algorithm using a reduced data set determined by a data reduction engine.

FIG. 4 illustrates pseudo-code for performing a distance based data mining clustering algorithm using a reduced data set determined by a data reduction engine.

FIG. 5 illustrates pseudo-code for the data reduction algorithm used to create data point bubbles.

FIG. 6 illustrates example data set clusters for an example data set in a distributed environment.

FIG. 7 illustrates pseudo-code for a DBSCAN algorithm.

FIG. 8 illustrates an example representation of three two-dimensional data sets and a corresponding informational table.

FIG. 9A illustrates an example result data set generated by executing DBSCAN on a D31 data set.

FIG. 9B illustrates an example graph illustrating the error rate effect of executing DBSCAN with a data reduction algorithm using various distance thresholds on a D31 data set.

FIG. 10A illustrates an example result data set generated by executing DBSCAN on a R15 data set.

FIG. 10B illustrates an example graph illustrating the error rate effect of executing DBSCAN with a data reduction algorithm using various distance thresholds on a R15 data set.

FIG. 11A illustrates an example result data set generated by executing DBSCAN on an aggregation data set.

FIG. 11B illustrates an example graph illustrating the error rate effect of executing DBSCAN with a data reduction algorithm using various distance thresholds on an aggregation data set.

FIG. 12A illustrates an example result data set generated by executing DBSCAN on an enlarged D31 data set.

FIG. 12B illustrates an example graph illustrating the computational cost effect of executing DBSCAN with the data reduction algorithm on an enlarged D31 data set using various distance thresholds.

FIG. 13A illustrates an example result data set generated by executing DBSCAN on a Bulls-eye data set.

FIG. 13B illustrates an example graph illustrating the computational cost effect of executing DBSCAN with a data reduction algorithm on a Bulls-eye data set using various distance thresholds.

FIG. 14A illustrates an example result data set generated by executing DBSCAN on an enlarged aggregation data set.

FIG. 14B illustrates an example graph illustrating the computational cost effect of executing DBSCAN with the data reduction algorithm on an enlarged aggregation data set using various distance thresholds.

FIG. 15 illustrates an example graph illustrating changes of an adjusted rank index (ARI) of various data distributions with respect to the use of various distance thresholds in the data reduction algorithm discussed herein.

Like reference numbers and designations in the various drawings indicate like elements.

### DETAILED DESCRIPTION

Aspects of the disclosed subject matter relate to techniques for using a data reduction algorithm for any clustering algorithm such as, for example, density-based spatial clustering of application with noise (DBSCAN) or k-th nearest neighbor algorithms. The data reduction algorithm groups data points in a data set into a number of data point bubbles. A representative point can be selected to represent the bubble. The representative points can be used to conduct clustering data mining analyses on the data set. The use of representative points reduces computational costs of the clustering data mining algorithm because the number of calculations needed to analyze the data set using the representative points is fewer than the number of calculations needed to analyze the data set using the full data set.

Clustering data mining analyses can be useful for solving many problems in class identification and data segmentation. For example, by clustering pixels in an image based on inter-pixel distances, different objects in the image can be identified. When handling large data sets, however, the computational cost of clustering algorithms may become prohibitively expensive, because the number of calculations increases quadratically with the number of data elements. Large data sets are often stored in a distributed environment. Because clustering data mining analyses often involve the global view of all of the data elements, distributed data further hinders the performance of these analyses. Though clustering algorithms are primarily used as examples, one skilled in the art will appreciate that the data reduction algorithm disclosed herein may be similarly beneficial for other machine learning methods, including, but not limited to supervised methods (e.g., regression and classification algorithms), and semi-supervised methods.

For example, data points in a data set can be described by two-dimensional feature points (x, y). Data points within the data set can be distributed on two or more computing nodes. Data points stored on computing node 2 can be transmitted through a network to computing node 1 before computing node 1 can calculate the distance between a data point on computing node 1 and a data point on computing node 2. This type of data movement can be expensive since network bandwidth is more limited than local memory bandwidth. Secondly, when handling large data sets in distributed format, it is infeasible to gather all remote data onto a single computing node due to limitation on local memory.

In a distributed computing environment, aspects and features of this disclosure can reduce the amount of data communication among computing nodes and reduce the computational cost of clustering calculations.

In one example, an original data set can be reduced several orders of magnitude without losing the characteristics of the original data in clustering data mining analysis. A number of “bubbles” can be created from a data set. A “bubble” is a group of one or more data points and one or more representative points, the group being aggregated by selecting at least one representative point and using a distance threshold to determine the one or more data points that are within the distance threshold. A data reduction algorithm can be executed to create bubbles from a data set in a distributed environment. The data reduction algorithm can be embedded in a distance-based algorithm such that a call to the distance-based algorithm first executes the data reduction algorithm to group the data set into multiple bubbles, extracts the representative points and then executes the distance-based algorithm on representative points rather than the full data set.

In one example, a distance threshold (Dₘₐₓ) may be received. The distance threshold can be passed as a parameter into the data reduction algorithm. The distance threshold can be received from a user. Each local data point can be assigned to a specific bubble based on the distance threshold. The distance threshold may be received from a user. Generally, larger distance thresholds correspond to a courser resolution generated by the data reduction method than the resolution generated using smaller distance thresholds. Representative points can be selected and used to perform clustering data mining analyses. For clustering data mining analysis, the representative point is assigned a cluster ID. The analysis results on each representative point can be propagated back to the original data points. For example, the data points in the same bubble as the representative point can be assigned the same cluster ID as the representative point.

Though the above examples utilize a distributed environment, a non-distributed computing environment in which a single computing node has a view of the entire data set can also benefit from the data reduction algorithm described herein by gathering the representative points and propagating the clustering results back to the original data points (e.g., assigning the cluster ID of the representative point cluster ID to data points in the same bubble as the representative point).

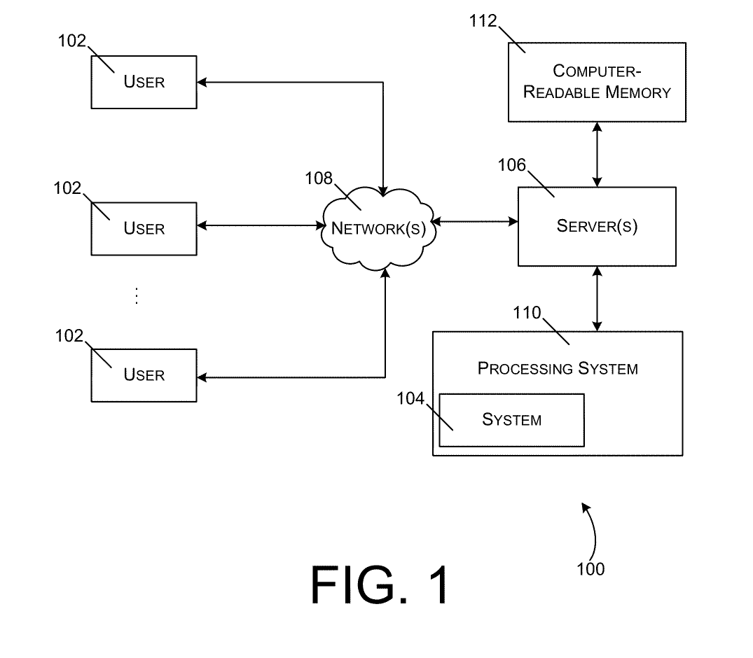

FIG. 1 illustrates an example block diagram of a computer-implemented environment 100 for reducing a number of computations executed for a clustering algorithm that analyzes data sets in a distributed data environment. Users 102 can interact with a system 104 hosted on one or more servers 106 through one or more networks 108. The system 104 can contain software operations or routines. The users 102 can interact with the system 104 through a number of ways, such as over networks 108. Servers 106, accessible through the networks 108, can host system 104. The system 104 can also be provided on a stand-alone computer for access by a user.

In one example, the environment 100 may include a stand-alone computer architecture where a processing system 110 (e.g., one or more computer processors) includes the system 104 being executed on it. The processing system 110 has access to a computer-readable memory 112.

In one example, the environment 100 may include a client-server architecture. Users 102 may utilize a PC to access servers 106 running a system 104 on a processing system 110 via networks 108. The servers 106 may access a computer-readable memory 112.

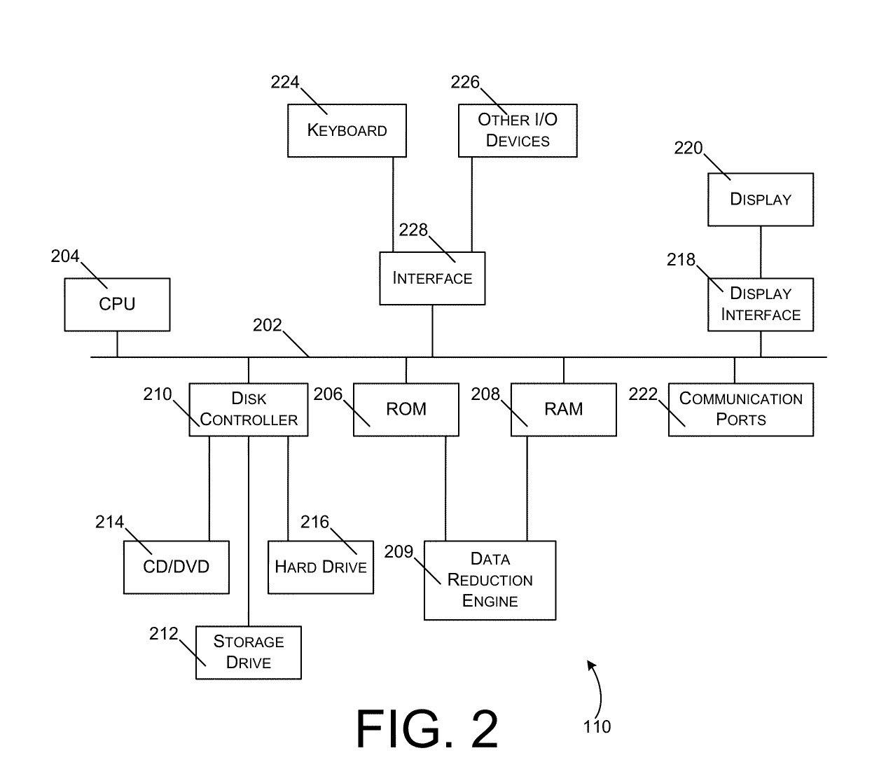

FIG. 2 illustrates a block diagram of an example processing system 110 of FIG. 1 for reducing a number of computations executed for a clustering algorithm that analyzes data sets in a distributed data environment. A bus 202 may interconnect the other illustrated components of processing system 110. Central processing unit (CPU) 204 (e.g., one or more computer processors) may perform calculations and logic operations used to execute a program. A processor-readable storage medium, such as read-only memory (ROM) 206 and random access memory (RAM) 208, may be in communication with the CPU 204 and may contain one or more programming instructions. Optionally, program instructions may be stored on a computer-readable storage medium, such as a magnetic disk, optical disk, recordable memory device, flash memory, or other physical storage medium. Computer instructions may also be communicated via a communications transmission, data stream, or a modulated carrier wave. In one example, program instructions implementing data reduction engine 209, as described further in this description, may be stored on storage drive 212, hard drive 216, read only memory (ROM) 206, random access memory (RAM) 208, or may exist as a stand-alone service external to the stand-alone computer architecture.

A disk controller 210 can interface one or more optional disk drives to the bus 202. These disk drives may be external or internal floppy disk drives such as storage drive 212, external or internal CD-ROM, CD-R, CD-RW, or DVD drives 214, or external or internal hard drive 216. As indicated previously, these various disk drives and disk controllers are optional devices.

A display interface 218 may permit information from the bus 202 to be displayed on a display 220 in audio, graphic, or alphanumeric format. Communication with external devices may optionally occur using various communication ports 222. In addition to the standard computer-type components, the hardware may also include data input devices, such as a keyboard 224, or other input/output devices 226, such as a microphone, remote control, touchpad, keypad, stylus, motion, or gesture sensor, location sensor, still or video camera, pointer, mouse or joystick, which can obtain information from bus 202 via interface 228.

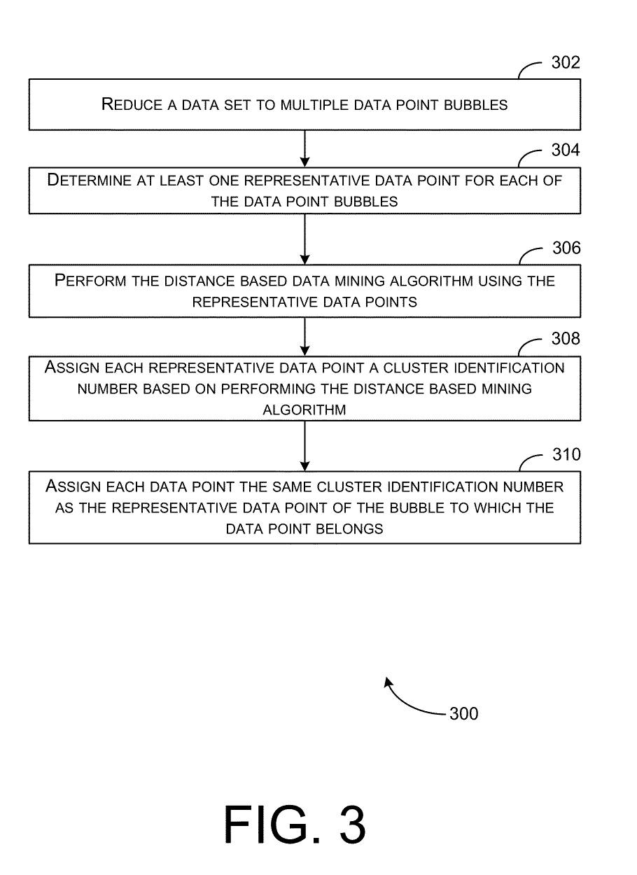

FIG. 3 illustrates an example flow diagram 300 for performing a distance based data mining algorithm using a reduced data set determined by a data reduction engine (e.g., data reduction engine 209). The flow diagram can begin at block 302 where data reduction engine 209 reduces a data set to multiple data point bubbles. The data points may exist in a distributed computing environment, but any suitable data set, in either a distributed environment or a non-distributed environment, may be utilized. Each bubble can include a single representative point and one or more data points. The representative point and each of the one or more data points exist in the data set.

At block 304, data reduction engine 209 determines at least one representative point for each data point bubble. In one example, each data point in the data set is assigned to a bubble. A representative point can be randomly selected from the assigned data points to represent the bubble. Alternatively, representative points can be selected in other ways, for example, by selecting a point closest to the center of the bubble.

At block 306, data reduction engine 209 performs the distance-based data mining algorithm using the representative points of the data point bubbles rather than the entire data set. “Distance” refers to a value of metric space between the selected data point and the representative point. For example, distance may refer to a Euclidean distance, a Manhattan distance, or a hammering distance. Data reduction engine 209 may alternatively pass the set of representative points to another component or engine to calculate cluster identification numbers for the representative points.

At block 308, data reduction engine 209 assigns each representative point a cluster identification number based on performing the distance based mining algorithm. Alternatively, data reduction engine 209, having passed the set of representative points to another component or engine to calculate cluster identification numbers, may receive clustering results for the set of representative points.

At block 310, data reduction engine 209 assigns each data point in each bubble the same cluster identification number as the representative point of the bubble to which the data point belongs.

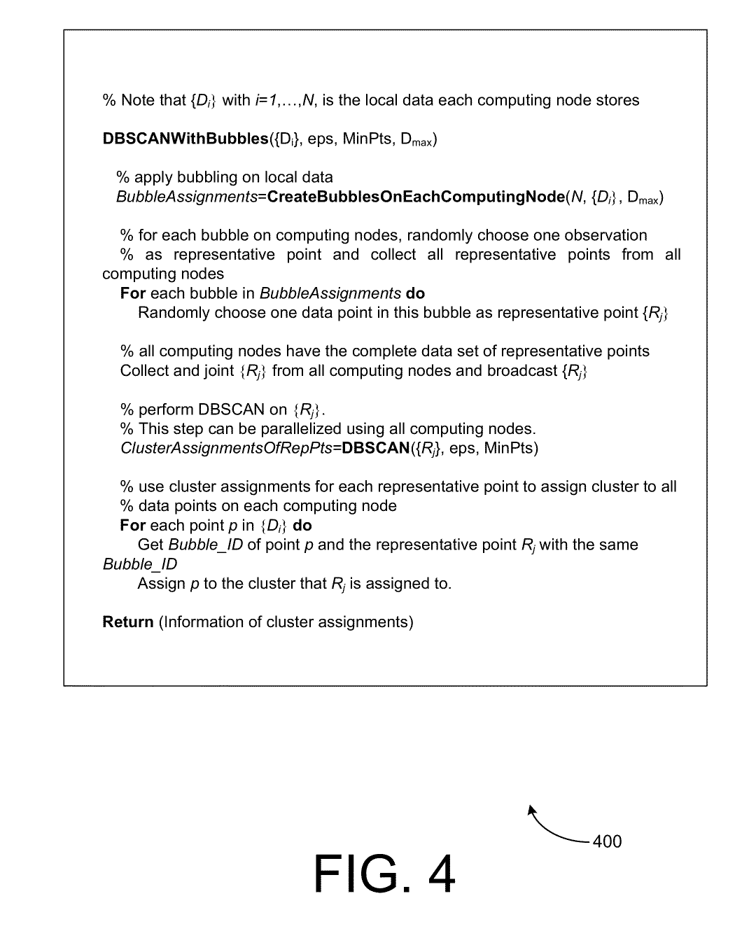

FIG. 4 illustrates pseudo-code for performing a distance-based data mining clustering algorithm using a reduced data set determined by a data reduction engine (e.g., data reduction engine 209) as described in FIG. 3. For example, FIG. 4 illustrates a function call DBSCANWithBubbles that includes four parameters: {Dᵢ}, eps, MinPts, and Dₘₐₓ, where Dᵢ is the data set, eps is a distance threshold used for the DBSCAN analysis, MinPts is a minimum number of data points in an eps-neighborhood of a point, and Dₘₐₓ is a distance threshold value used to determine the diameter of the data bubbles.

Pseudo-code 400 includes a function call to CreateBubblesOnEachComputingNode in order to determine bubbles of a local data set. Once bubbles are determined, a data point in the bubble is selected as the representative point for the bubble. Though one representative point is used in this example, a bubble may include one or more representative points. One skilled in the art will appreciate that selecting more than one representative point can be beneficial in stabilizing the bubbling algorithm. The one or more representative points may be selected randomly or in other ways as would be apparent to one skilled in the art.

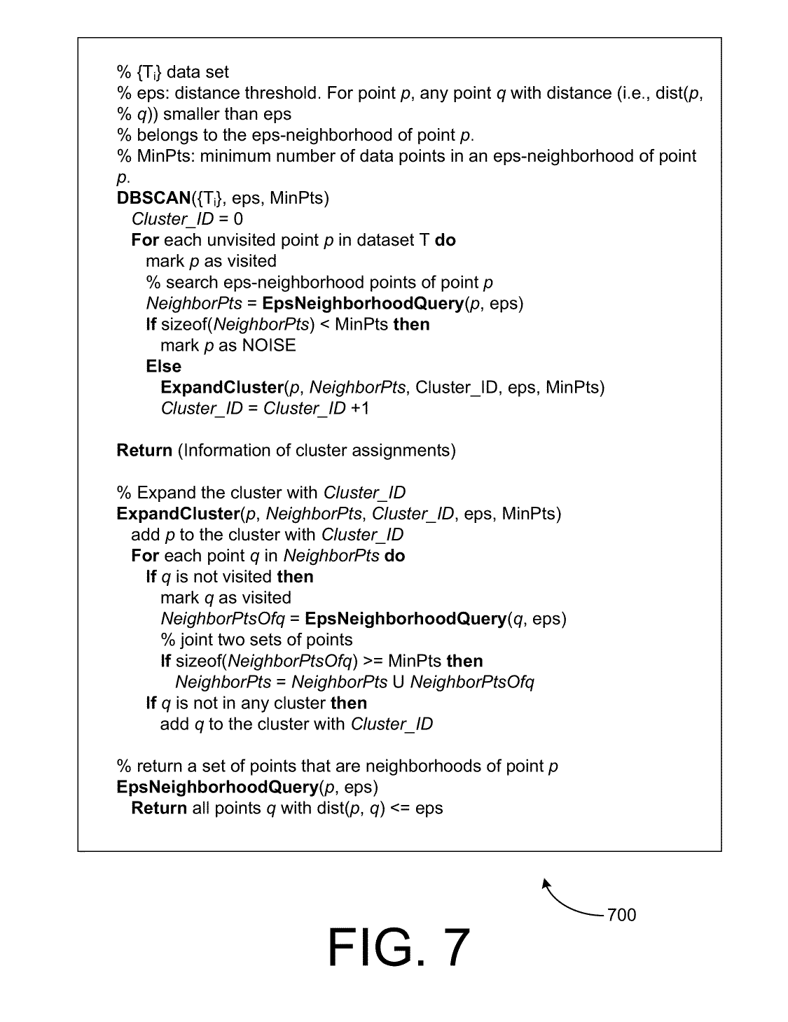

Once representative points are determined, the representative points are collected into data set Rⱼ. Data set Rⱼ may be used to perform DBSCAN. The pseudo-code for DBSCAN is illustrated in FIG. 7. The execution of DBSCAN using the representative points (data set Rⱼ) returns the cluster assignments of the representative points.

The algorithm concludes by assigning a cluster identification number to each data point in the original data set D. This is accomplished by selecting a data point, determining the representative point of the bubble to which the data point belongs, determining the cluster identification number of the representative point, and assigning the cluster identification number to the data point. The DBSCANWithBubbles function then returns information of the cluster assignments.

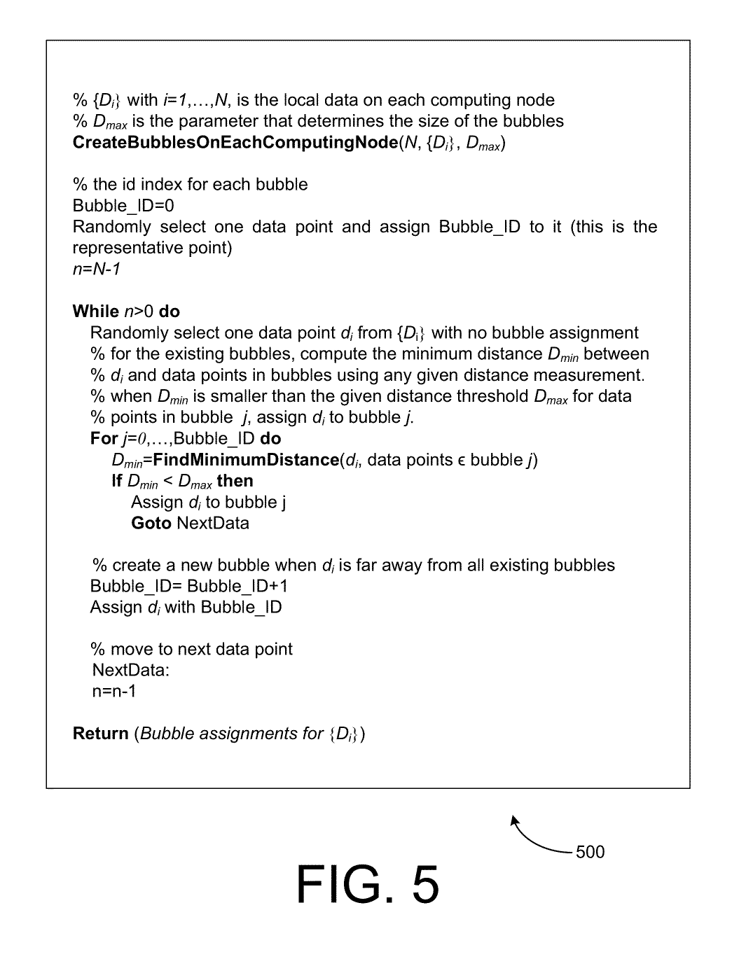

FIG. 5 illustrates pseudo-code 500 for the data reduction algorithm used to create data point bubbles. The process to reduce the data set to multiple bubbles, described in block 302 and pseudo-code 400, may include an algorithm similar to the one illustrated in FIG. 5. For example, FIG. 5 illustrates a function call CreateBubblesOnEachComputingNode that includes three parameters: N, {Dᵢ}, and Dₘₐₓ, where N is the local data on each computing node, Dᵢ is the data set, and Dₘₐₓ is a distance threshold value used to determine the size of the data bubbles. Pseudo-code 500 includes selecting one data point, assigning a bubble identification number to the data point, and designating that data point as a representative point of the bubble. A data point (dᵢ), having no bubble assignment, may be randomly selected from the data set Dᵢ. A minimum distance Dₘᵢₙ may be computed between the selected data point and other data points already assigned to a bubble in order to find the closest point to dᵢ. If a closest data point (dₐ) in the data set is a metric distance less than Dₘₐₓ away from the representative point but greater than Dₘᵢₙ, the data point dᵢ can be assigned to the same bubble identification number as dₐ. If dₐ is more than Dₘₐₓ away from dᵢ, dᵢ may not be assigned to the same bubble as dₐ. The process of selecting a representative point and determining data points to assign to the bubble represented by the representative point may be repeated.

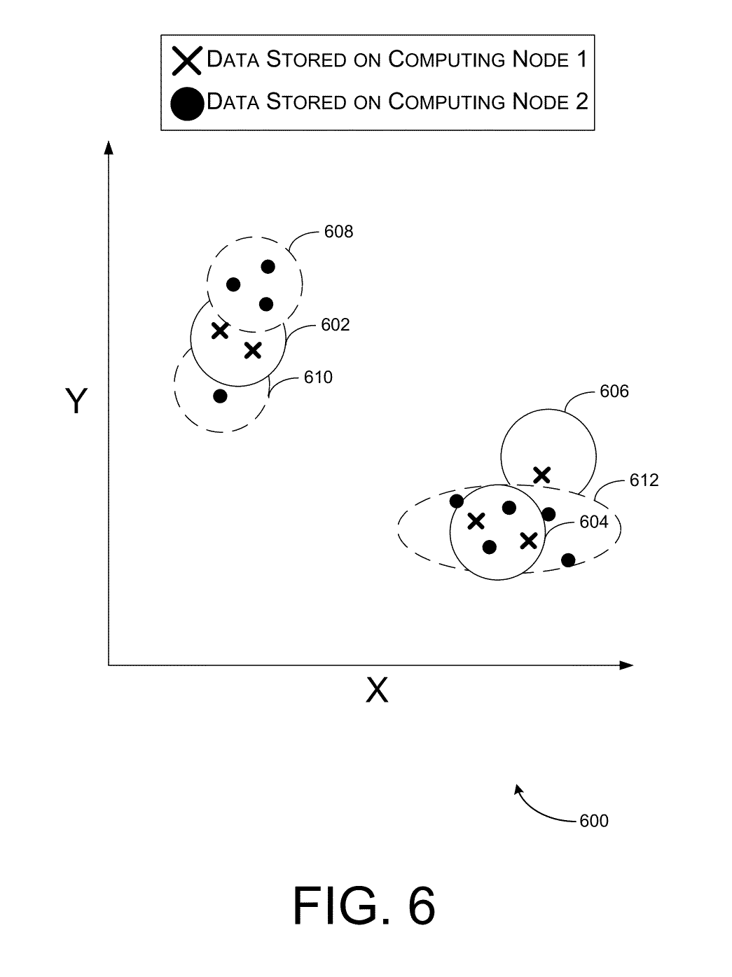

FIG. 6 shows example data set bubbles for an example data set in a distributed environment 600. Using the data set shown in FIG. 6 as an example, several bubbles can be determined for the data points on two computing nodes using the aforementioned data reduction algorithm. An “X” represents a data point stored on computing node 1. A dot represents a data point stored on computing node 2. Using the data reduction algorithm, bubbles 602, 604, and 606 can be created on computing node 1 and bubbles 608, 610, and 612 can be created on computing node 2. After these bubbles are assigned, representative points can be randomly chosen from each bubble and sent to all the computing nodes. Traditional distance-based clustering algorithms can then be applied to the representative points. Though a single representative point per bubble is chosen in the example above, the number of representative points to be assigned per bubble is adjustable.

In one example, consider that the data set of FIG. 6 is intended to be analyzed with a data clustering algorithm such as DBSCAN. The pseudo-code 700 for the DBSCAN algorithm is depicted in FIG. 7. Pseudo-code 700 includes a function call to a DBSCAN function having three parameters: {Tᵢ}, eps, and MinPts, where {Tᵢ} is a data set, eps is a distance threshold used for the DBSCAN analysis, and MinPts is a minimum number of data points in an eps-neighborhood. In the DBSCAN algorithm illustrated, a variable cluster_ID is initially set to 0. For each unvisited point p in data set T, the algorithm marks p visited and calls the function EpsNeighborhoodQuery, passing the EpsNeighborhoodQuery point p and distance threshold eps.

EpsNeighborhoodQuery returns a set of points that are in the neighborhood of point p, that is, a set of points that are less than eps distance away from point p. The algorithm makes a determination as to whether the returned set of points exceeds MinPts. If the set of points contains a number of points less than MinPts, then point p is marked as NOISE. If the set of points contains a number of points that is greater than MinPts, then the function ExpandCluster is called.

The function ExpandCluster is passed five parameters: p, NeighborPts, Cluster_ID, eps, and MinPts, where p is the current point, NeighborPts is the set of neighborhood points returned from EpsNeighborhoodQuery, Cluster_ID is the current cluster identification number, eps is a distance threshold, and MinPts is a minimum number of data points in an eps-neighborhood of points. ExpandCluster adds point p to the cluster by assigning p the current value of cluster_ID. For each point q in the set of NeighborPts, if point q has not been visited, point q is marked as visited and neighborhood points of point q are determined by calling function EpsNeighborhoodQuery in a similar manner as described above. If the size of the set of neighborhood points of point q is greater than, or equal to, the size of NeighborPts, then the set neighborhood points of point q is joined with NeighborPts (the set of neighborhood points of point p). If point q is not in any cluster, then point q is assigned to the cluster represented by cluster_ID. The DBSCAN algorithm is repeated for each point p in data set Tᵢ.

Though DBSCAN is used as an example distance-based algorithm, other data clustering algorithms may be utilized with the data reduction algorithm described herein.

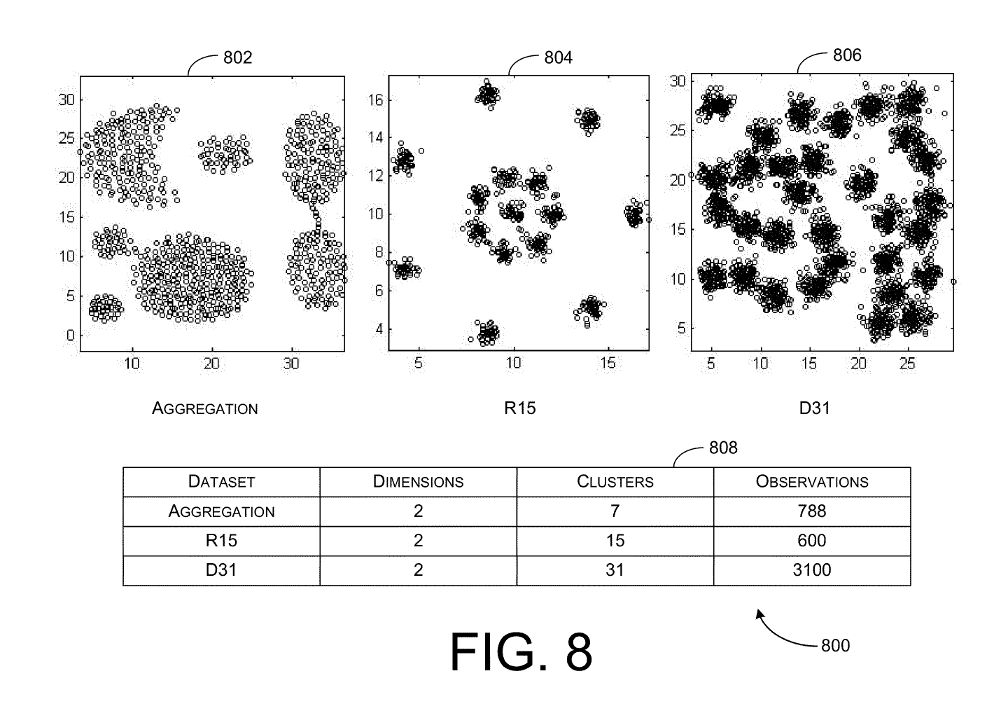

FIGS. 8 to 15 illustrate various test results gathered using the data reduction algorithm on traditional data sets, the traditional data sets being data sets that are often utilized by the data mining community to conduct performance and accuracy testing. In order to verify how the data reduction algorithm may modify the results of DBSCAN, the data reduction algorithm may be applied to various synthetic data domains “D31,” “R15,” “aggregation,” and “Bulls-Eye.” Each data set is two-dimensional and the cluster assignments of each data point are known. The error rate can be computed by the percentage of mis-clustered data points.

FIG. 8 illustrates an example representation 800 of three two-dimension data sets and a corresponding informational table. At 802, an aggregation data set is illustrated. The aggregation data set has seven clusters and 788 observations, as shown in table 808. At 804, an “R15” data set is shown. The R15 data set has 15 clusters and 600 observations as shown in table 808. At 806, a “D31” data set is shown. The D31 data set has 31 clusters and 3100 observations as shown in table 808.

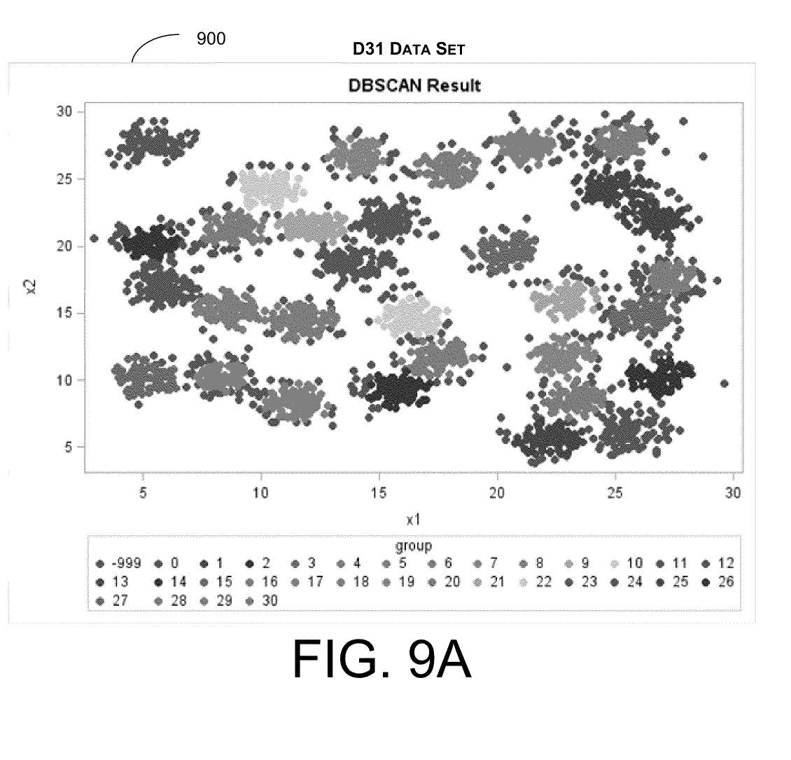

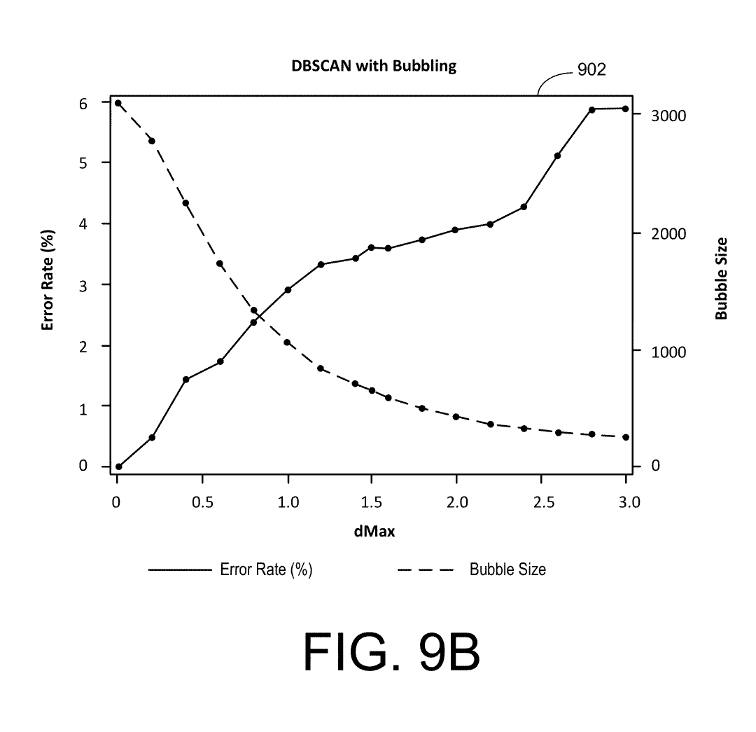

FIG. 9A illustrates an example result data set 900 generated by executing DBSCAN on a D31 data set without utilizing the data reduction algorithm described herein. Error rates for the data reduction algorithm may be computed as a percentage of mis-clustered data points, with traditional DBSCAN results illustrated in FIG. 9A used as a benchmark.

FIG. 9B illustrates an example graph 902 illustrating the error rate effect of executing DBSCAN with a data reduction algorithm using various distance thresholds on a D31 data set. The data reduction algorithm in this example used Eps=1.0 and MinPtrs=50. As shown in FIG. 9B, the error rate of DBSCAN with clustering can be increased when larger Dₘₐₓ values are used because data reduction can be more aggressive and representative points may not be able to represent the original data set. For the D31 data set, when Dₘₐₓ=3.0, only 253 clusters are created. The original 3,000 data points are represented by 253 representative points (one point per bubble). This reduces the size of data set by one order of magnitude. For this most coarse case, the error rate is only 6%. “Bubble size” as used in FIG. 9B refers to the number of bubbles created by the data reduction algorithm.

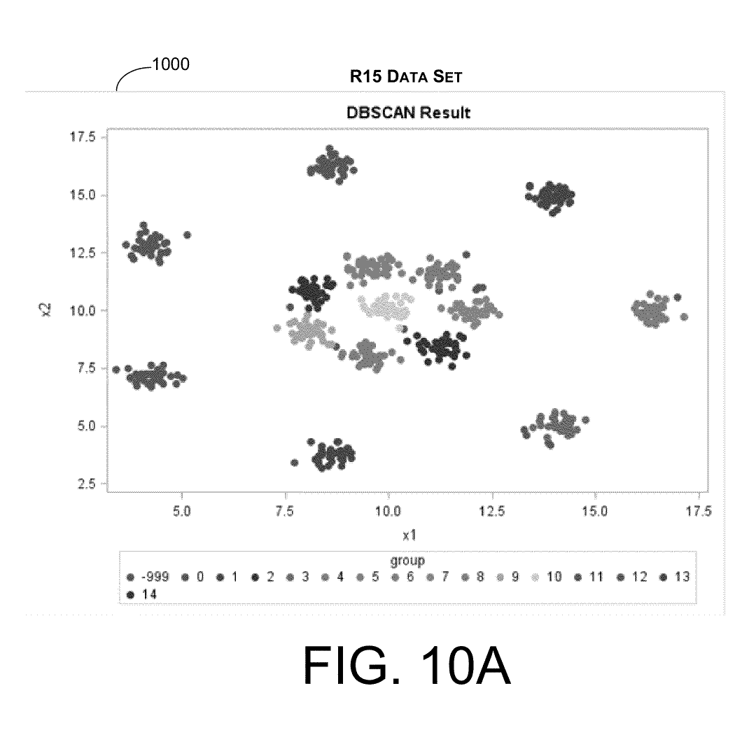

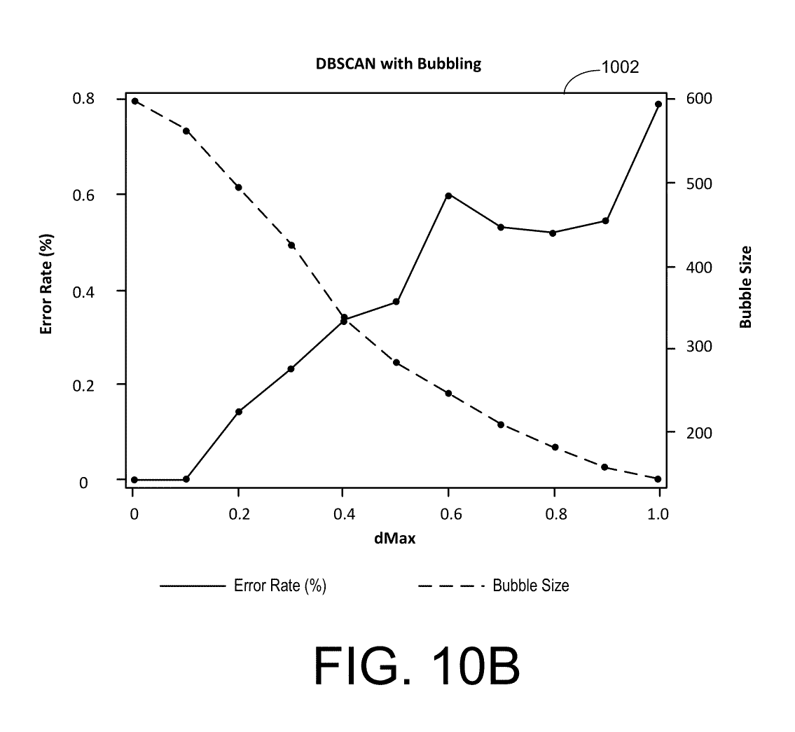

FIG. 10A illustrates an example result data set 1000 generated by executing DBSCAN on an R15 data set without utilizing the data reduction algorithm described herein. Error rates for the data reduction algorithm may be computed as a percentage of mis-clustered data points, with traditional DBSCAN results illustrated in FIG. 10A used as a benchmark.

FIG. 10B illustrates an example graph 1002 illustrating the error rate effect of executing DBSCAN with a data reduction algorithm using various distance thresholds on an R15 data set. The data reduction algorithm in this example used Eps=0.5 and MinPtrs=15. As shown in FIG. 10B, the error rate of DBSCAN with clustering can be increased when larger Dₘₐₓ values are used because data reduction can be more aggressive and representative points may not be able to represent the original data set. For example, using the R15 data set, when Dₘₐₓ=0.8, 180 clusters are created. As such, the original 600 data points are represented by 180 representative points (one representative point per bubble). This can reduce the size of data set. The error rate for such a case is only 0.1%.

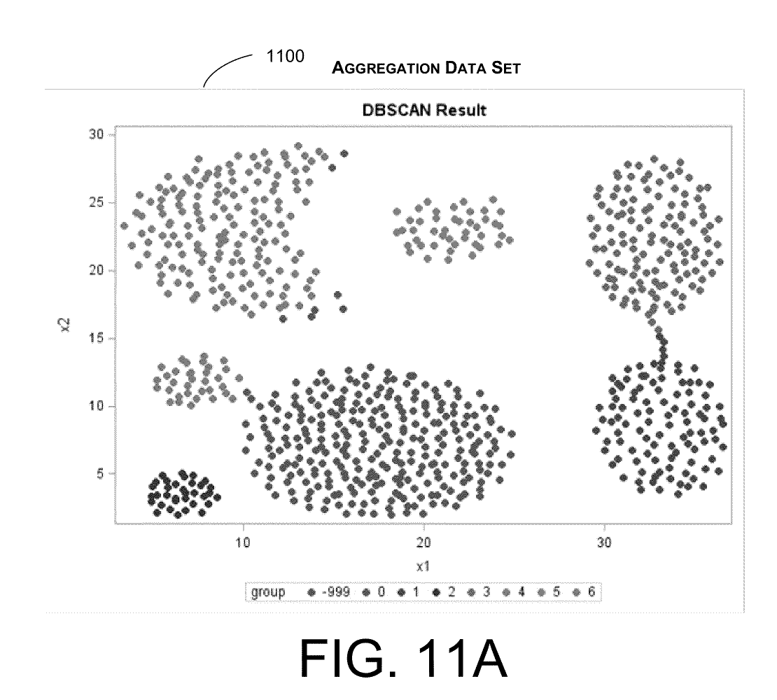

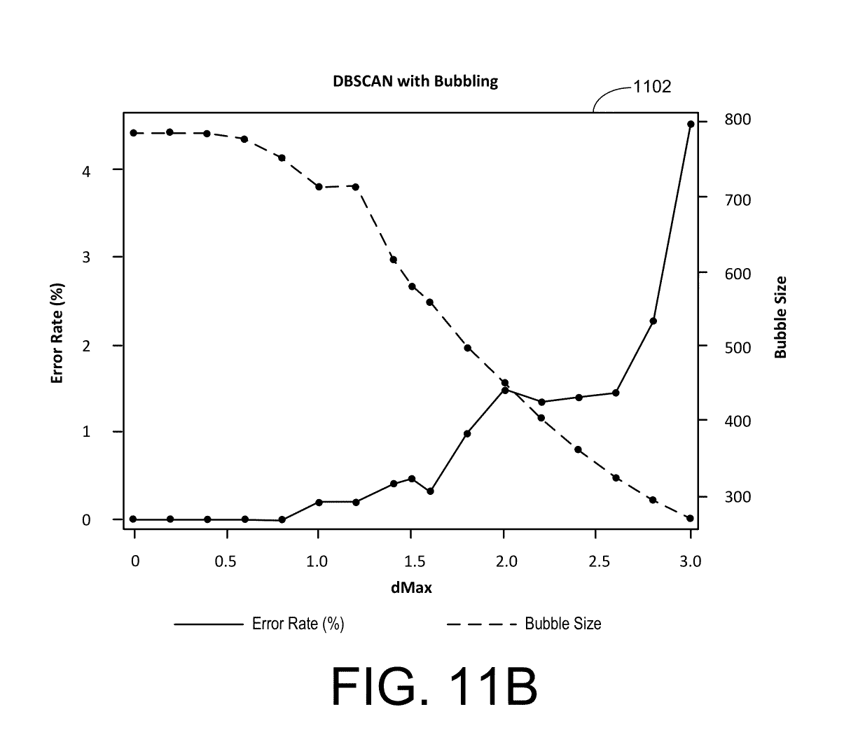

FIG. 11A illustrates an example result data set 1100 generated by executing DBSCAN on an aggregation data set without utilizing the data reduction algorithm described herein. Error rates for the data reduction algorithm may be computed as a percentage of mis-clustered data points, with traditional DBSCAN results illustrated in FIG. 11A used as a benchmark.

FIG. 11B illustrates an example graph 1102 illustrating the error rate effect of executing DBSCAN with a data reduction algorithm using various distance thresholds on an aggregation data set. The data reduction algorithm in this example used Eps=2.0 and MinPtrs=15. As shown in FIG. 11B, the error rate of DBSCAN with clustering can be increased when larger Dₘₐₓ values are used because data reduction can be more aggressive and representative points may not be able to represent the original data set. For example, using the aggregation data set, when Dₘₐₓ=3.0, 100 clusters are created. The original 788 data points are represented by 100 representative points (one representative point per bubble). This reduces the size of the data set. The error rate for such a case is only 4.4%.

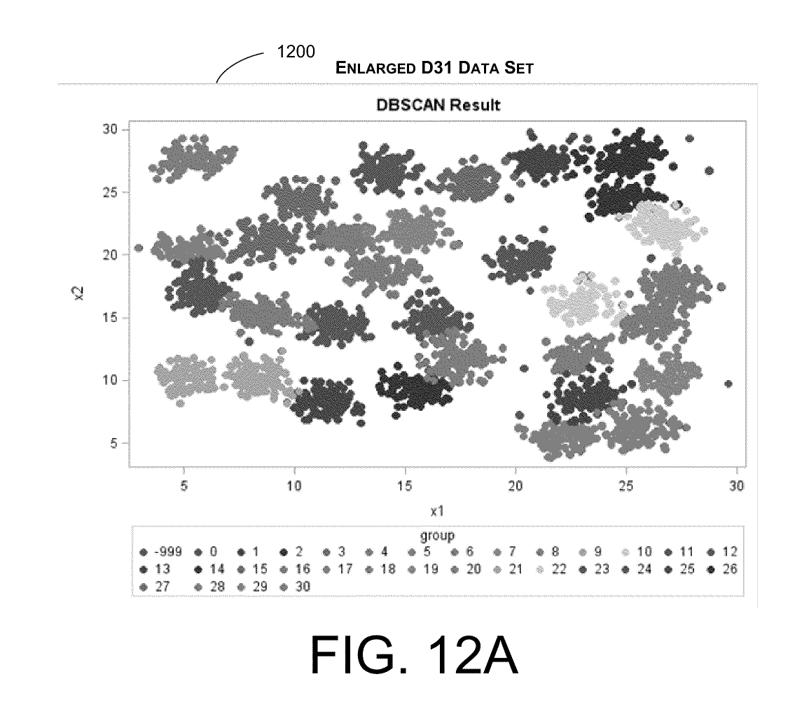

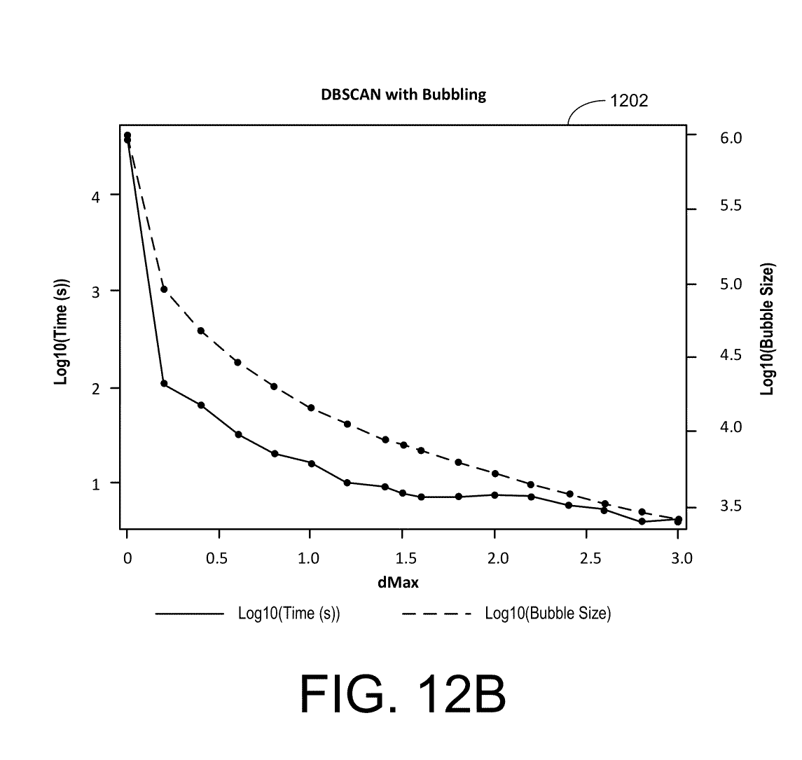

FIG. 12A illustrates an example result data set 1200 generated by executing DBSCAN on an enlarged D31 data set without utilizing the data reduction algorithm described herein. Here, the data set includes 93,000 observations. The “−999” grouping indicates the points that are clustered as noise.

FIG. 12B illustrates an example graph 1202 illustrating the computational cost effect of executing DBSCAN with the data reduction algorithm on an enlarged D31 data set using various distance thresholds. As shown in FIG. 12B, the computational cost (time in second) of DBSCAN with clustering can be decreased when larger Dₘₐₓ values are used. For example, using an enlarged D31 data set with 93,000 observations, when Dₘₐₓ increases, the computational cost is decreased.

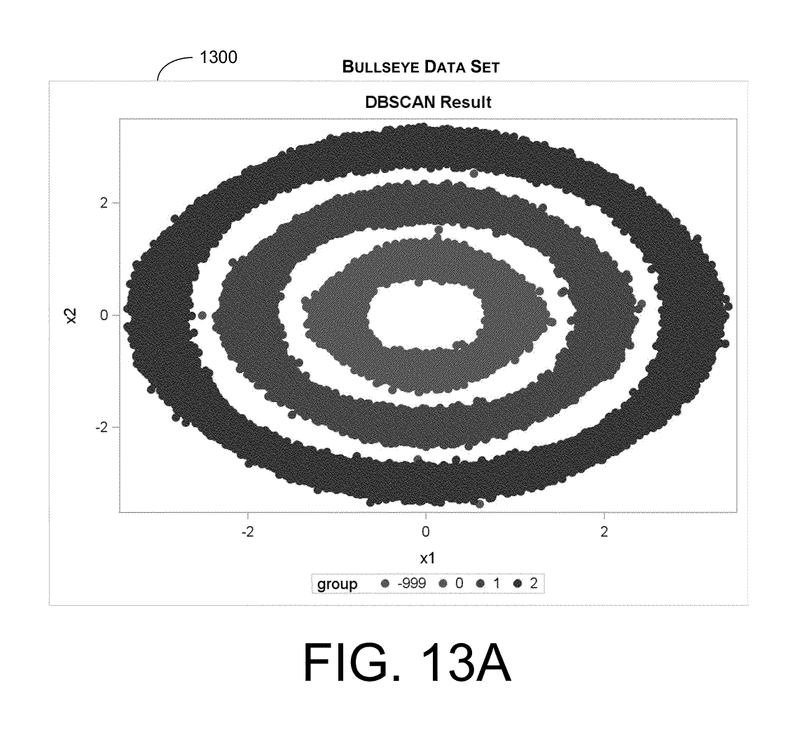

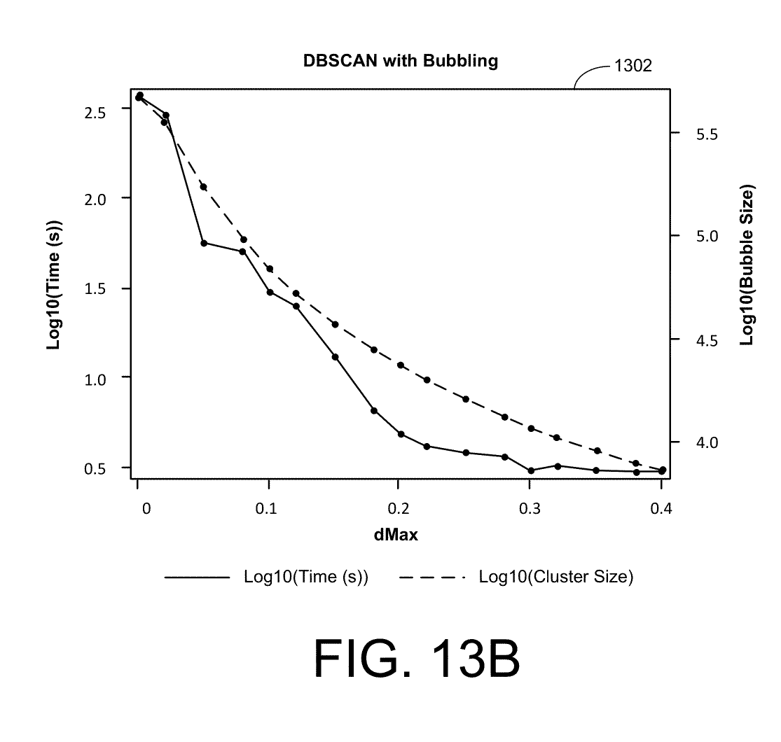

FIG. 13A illustrates an example result data set 1300 generated by executing a traditional DBSCAN on a Bulls-eye data set without utilizing the data reduction algorithm described herein. Here, the data set includes 480,000 observations. The “−999” grouping indicates the points that are clustered as noise.

FIG. 13B illustrates an example graph 1302 illustrating the computational cost effect of executing DBSCAN with a data reduction algorithm on a Bulls-eye data set using various distance thresholds. As shown in FIG. 13B, the computational cost (time in seconds) of DBSCAN with clustering can be decreased when larger Dₘₐₓ values are used. For example, using an enlarged Bulls-eye data set with 480,000 observations, when Dₘₐₓ increases, the computational cost is decreased.

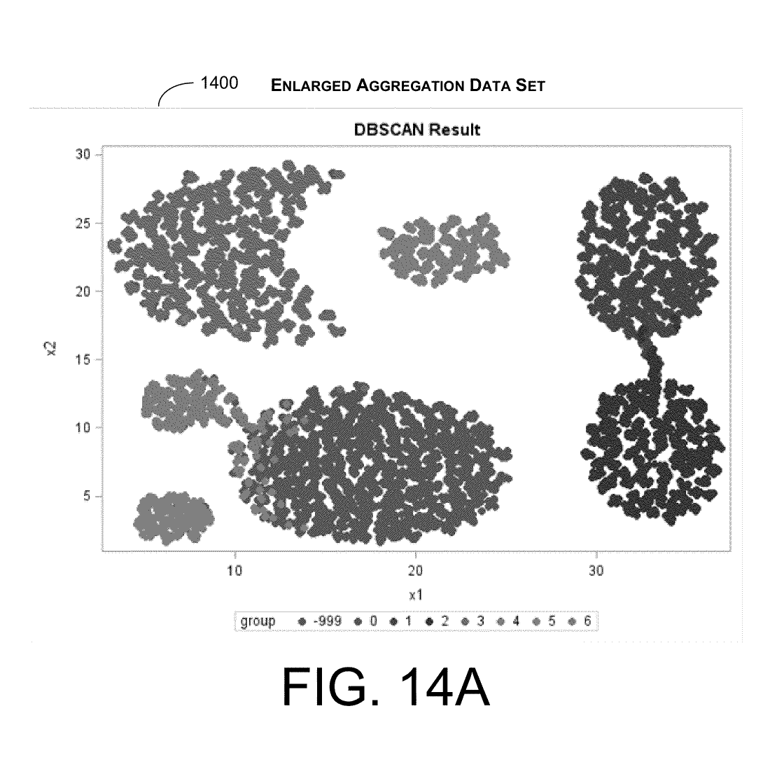

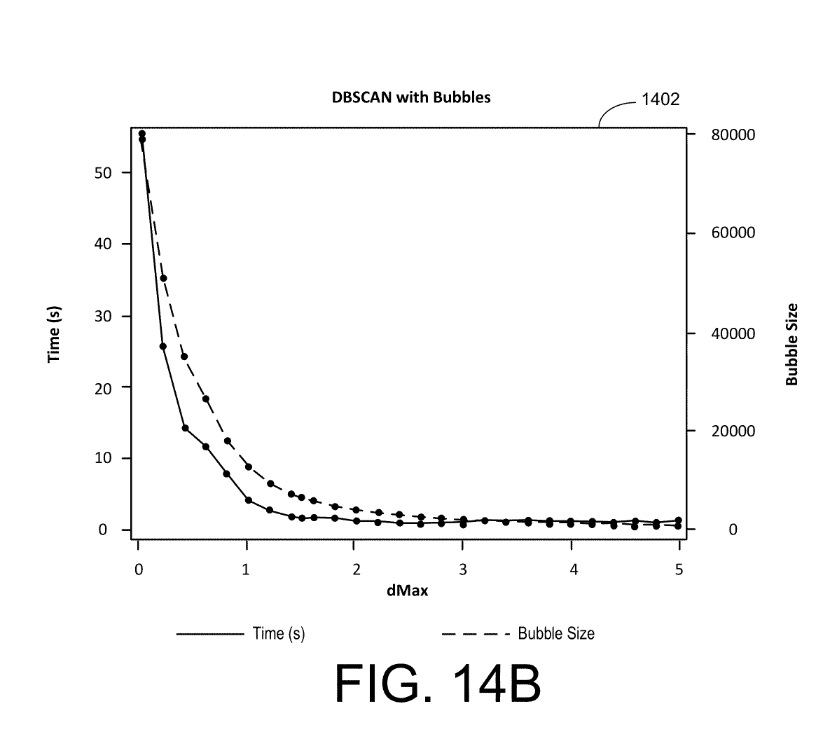

FIG. 14A illustrates an example result data set 1400 generated by executing DBSCAN on an enlarged aggregation data set without utilizing the data reduction algorithm described herein. Here, the data set includes 78,800 observations. The “−999” grouping indicates the points that are clustered as noise.

FIG. 14B illustrates an example graph 1402 illustrating the computational cost effect of executing DBSCAN with the data reduction algorithm on an enlarged aggregation data set using various distance thresholds. As shown in FIG. 14B, the computational cost (time in seconds) of DBSCAN with clustering can be decreased when larger Dₘₐₓ values are used. For example, using an enlarged aggregation data set with 78,800 observations, when Dₘₐₓ increases, the computational cost is decreased.

Overall, the clustering algorithm can efficiently reduce the size of data no matter how big data are distributed across computing nodes. Using the DBSCAN clustering algorithm as one example of bubbling applications, we also demonstrate that the clustering results are not altered significantly when the sole parameter Dₘₐₓ is tuned. Tuning Dₘₐₓ for DBSCAN is straightforward and one can use Eps for Dₘₐₓ as well. It is worth emphasizing that the clustering algorithm is universal and can be readily ported to other data mining algorithms such as k-nearest neighbor analysis or k-means clustering.

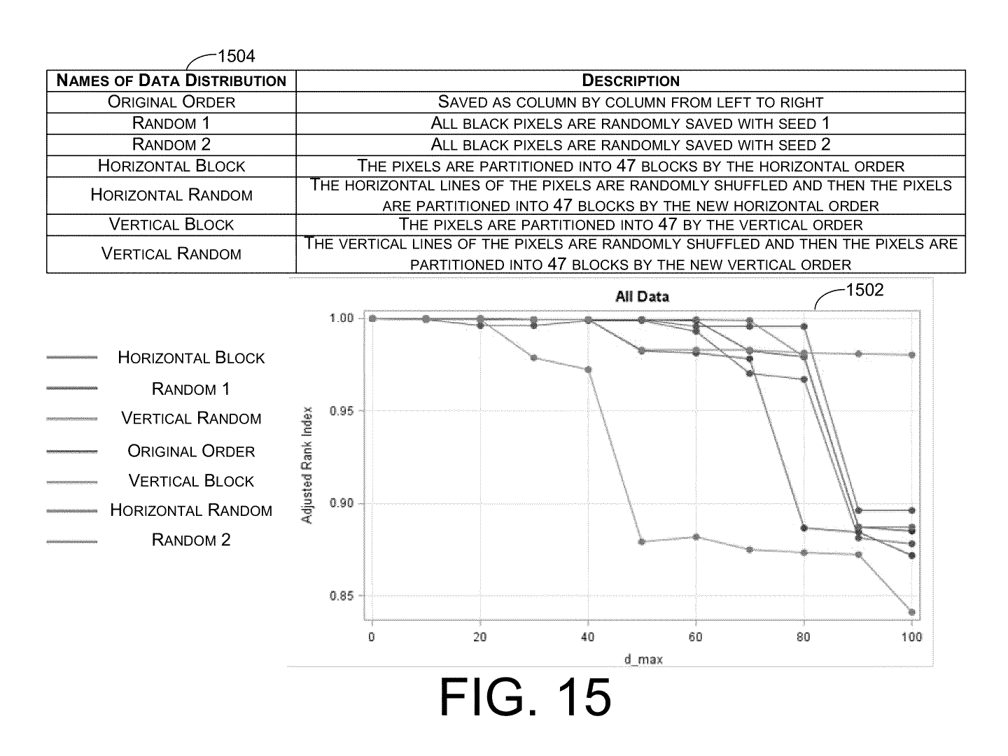

FIG. 15 shows an example graph 1502 illustrating changes of an Adjusted Rand Index (ARI) of various data distributions 1504 with respect to the use of various distance thresholds in the data reduction algorithm discussed herein. An ARI is a value from 0 to 1 representing a similarity comparison between two data clusters where 1 represents identical results. As can be seen from graph 1502, even as Dₘₐₓ is increased, the data results between DBSCAN executed without the data reduction algorithm and DBSCAN executed with the data reduction algorithm still maintain above an 80% accuracy rate. Graph 1502 indicates further that, other than the vertical block data distribution, the results of running DBSCAN with the data reduction algorithm using the other data distributions maintain above a 95% accuracy rate until Dₘₐₓ approaches 85.

Systems and methods according to some examples may include data transmissions conveyed via networks (e.g., local area network, wide area network, Internet, or combinations thereof, etc.), fiber optic medium, carrier waves, wireless networks, etc. for communication with one or more data processing devices. The data transmissions can carry any or all of the data disclosed herein that is provided to, or from, a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, removable memory, flat files, temporary memory, databases, programming data structures, programming variables, IF-THEN (or similar type) statement constructs, etc.). It is noted that data structures may describe formats for use in organizing and storing data in databases, programs, memory, or other computer-readable media for use by a computer program.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows and figures described and shown in this specification can be performed by one or more programmable processors executing one or more computer programs to perform functions by operating on input data and generating output.

Generally, a computer can also include, or be operatively coupled to receive data from or transfer data to, or both, one or more mass storage devices for storing data (e.g., magnetic, magneto optical disks, or optical disks). However, a computer need not have such devices. Moreover, a computer can be embedded in another device, (e.g., a mobile telephone, a personal digital assistant (PDA), a tablet, a mobile viewing device, a mobile audio player, a Global Positioning System (GPS) receiver), to name just a few. Computer-readable media suitable for storing computer program instructions and data include all forms of nonvolatile memory, media and memory devices, including by way of example semiconductor memory devices (e.g., EPROM, EEPROM, and flash memory devices); magnetic disks (e.g., internal hard disks or removable disks; magneto optical disks; and CD ROM and DVD-ROM disks). The processor and the memory can be supplemented by, or incorporated in, special purpose logic circuitry.

The computer components, software modules, functions, data stores and data structures described herein may be connected directly or indirectly to each other in order to allow the flow of data needed for their operations. It is also noted that a module or processor includes, but is not limited to, a unit of code that performs a software operation, and can be implemented, for example, as a subroutine unit of code, or as a software function unit of code, or as an object (as in an object-oriented paradigm), or as an applet, or in a computer script language, or as another type of computer code. The software components or functionality may be located on a single computer or distributed across multiple computers depending upon the situation at hand.

The computer may include a programmable machine that performs high-speed processing of numbers, as well as of text, graphics, symbols, and sound. The computer can process, generate, or transform data. The computer includes a central processing unit that interprets and executes instructions; input devices, such as a keyboard, keypad, or a mouse, through which data and commands enter the computer; memory that enables the computer to store programs and data; and output devices, such as printers and display screens, that show the results after the computer has processed, generated, or transformed data.

Implementations of the subject matter and the functional operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer program products (i.e., one or more modules of computer program instructions encoded on a computer-readable medium for execution by, or to control the operation of, data processing apparatus). The computer-readable medium can be a machine-readable storage device, a machine-readable storage substrate, a memory device, a composition of matter effecting a machine-readable propagated, processed communication, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question (e.g., code that constitutes processor firmware, a protocol stack, a graphical system, a database management system, an operating system, or a combination of one or more of them).

While this disclosure may contain many specifics, these should not be construed as limitations on the scope of what may be claimed, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software or hardware product or packaged into multiple software or hardware products.

Some systems may use Hadoop@, an open-source framework for storing and analyzing big data in a distributed computing environment. Some systems may use cloud computing, which can enable ubiquitous, convenient, on-demand network access to a shared pool of configurable computing resources (e.g., networks, servers, storage, applications and services) that can be rapidly provisioned and released with minimal management effort or service provider interaction. Some grid systems may be implemented as a multi-node Hadoop® cluster, as understood by a person of skill in the art. Apache™ Hadoop® is an open-source software framework for distributed computing. Some systems may use the SAS® LASR™ Analytic Server in order to deliver statistical modeling and machine learning capabilities in a highly interactive programming environment, which may enable multiple users to concurrently manage data, transform variables, perform exploratory analysis, build and compare models and score with virtually no regards to the size of the data stored in Hadoop®. Some systems may use SAS In-Memory Statistics for Hadoop® to read big data once and analyze it several times by persisting it in-memory for the entire session.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situation where only the disjunctive meaning may apply.

What is claimed is:

1. A computer-program product tangibly embodied in a non-transitory machine-readable storage medium, including instructions configured to be executed to cause a data processing apparatus to:
group data points in a data set into a plurality of data point bubbles represented by a plurality of representative points, wherein an individual data point bubble of the plurality of data point bubbles comprises one or more data points from the data set and a representative point of the plurality of representative points; and
calculate a cluster assignment for the representative point by executing a clustering algorithm using the plurality of representative points.

2. The computer-program product of claim 1, wherein the instructions are further configured to be executed to cause the data processing apparatus to assign the cluster assignment of the representative point to individual data points of the one or more data points.

3. The computer-program product of claim 1, wherein the clustering algorithm is a distance-based data mining analysis algorithm.

4. The computer-program product of claim 1, wherein the cluster assignment is calculated in parallel with respect to other cluster assignments of the plurality of representative points.

5. The computer-program product of claim 1, wherein the instructions configured to be executed to group the data points in the data set are further configured with instructions to be executed to:
receive configuration information used to group the data points in the data set into the plurality of data point bubbles;
for a subset of the data points in the data set:
compute a distance measurement between a particular data point of the subset and an individual data point of a particular data point bubble of the plurality of data point bubbles; and
assign the particular data point a bubble identification number of an individual data point bubble based on the configuration information and the distance measurement; and
select the representative point for the individual data point bubble from the subset.

6. The computer-program product of claim 5, wherein the data set is distributed over two or more computing nodes in a distributed environment.

7. The computer-program product of claim 5, wherein the configuration information includes a maximum distance threshold.

8. The computer-program product of claim 7, wherein the instructions are further configured to be executed to cause the data processing apparatus to, for the subset of the data points, assign the particular data point the bubble identification number when the computed distance measurement is less than the maximum distance threshold.

9. The computer-program product of claim 6, wherein the distance measurement corresponds to a value of metric space between the particular data point of the subset and the individual data point of the particular data point bubble.

10. A computer-implemented method, comprising:
grouping, by a computing system, data points in a data set into a plurality of data point bubbles represented by a plurality of representative points, wherein an individual data point bubble of the plurality of data point bubbles comprises one or more data points from the data set and a representative point of the plurality of representative points; and
calculating, by the computing system, a cluster assignment for the representative point by executing a clustering algorithm using the plurality of representative points.

11. The computer-implemented method of claim 10, further comprising assigning the cluster assignment to individual data points of the one or more data points.

12. The computer-implemented method of claim 10, wherein the clustering algorithm is a distance-based data mining analysis algorithm.

13. The computer-implemented method of claim 10, wherein the cluster assignment is calculated in parallel with respect to other cluster assignments of the plurality of representative points.

14. The computer-implemented method of claim 10, wherein grouping the data points in the data set further comprises:
receiving configuration information used to group the data points in the data set into the plurality of data point bubbles;
for a subset of the data points in the data set:
computing a distance measurement between a particular data point of the subset and an individual data point of a particular data point bubble of the plurality of data point bubbles; and
assigning the particular data point a bubble identification number based on the configuration information and the distance measurement; and
select the representative point for the individual data point bubble from the subset.

15. The computer-implemented method of claim 14, wherein the data set is distributed over two or more computing nodes in a distributed environment.

16. The computer-implemented method of claim 14, wherein the configuration information includes a maximum distance threshold.

17. The computer-implemented method of claim 16, further comprising assigning the particular data point the bubble identification number when the computed distance measurement is less than the maximum distance threshold.

18. The computer-implemented method of claim 17, wherein the distance measurement corresponds to a value of metric space between the particular data point of the subset and the individual data point of the particular data point bubble.

19. A system, comprising:
a processor; and
a non-transitory computer-readable storage medium including instructions configured to be executed that, when executed by the processor, cause the system to perform operations including:
grouping data points in a data set into a plurality of data point bubbles represented by a plurality of representative points, wherein an individual data point bubble of the plurality of data point bubbles comprises one or more data points from the data set and a representative point of the plurality of representative points; and
calculating a cluster assignment for the representative point by executing a clustering algorithm using the plurality of representative points.

20. The system of claim 19, including further instructions configured to be executed that, when executed by the processor, cause the system to perform further operations including assigning the cluster assignment to individual data points of the one or more data points.

21. The system of claim 19, wherein the clustering algorithm is a distance-based data mining analysis algorithm.

22. The system of claim 19, wherein the cluster assignment is calculated in parallel with respect to other cluster assignments of the plurality of representative points.

23. The system of claim 19, wherein the instructions that are, when executed by the processor, configured to group the data points in the data set, include further instructions that are configured to, when executed by the processor, cause the system to perform operations including:
receiving configuration information used to group the data points in the data set into the plurality of data point bubbles;
for a subset of the data points in the data set:
computing a distance measurement between a particular data point of the subset and an individual data point of a particular data point bubble of the plurality of data point bubbles; and
assigning the particular data point a bubble identification number based on the configuration information and the distance measurement; and
select the representative point for the individual data point bubble from the subset.

24. The system of claim 23, wherein the data set is distributed over two or more computing nodes in a distributed environment.

25. The system of claim 23, wherein the configuration information includes a maximum distance threshold.

26. The system of claim 25, wherein the instructions that are further configured to be executed to cause a data processing apparatus to, for the subset of the data points, assign the particular data point the bubble identification number when the computed distance measurement is less than the maximum distance threshold.

27. The system of claim 26, wherein the distance measurement corresponds to a value of metric space between the particular data point of the subset and the individual data point of the particular data point bubble.
